(19) United States
(12) Patent Application Publication
(10) Pub. No.: US 2026/0062547 A1
(43) Pub. Date: Mar. 5, 2026

(54) CROSSLINKING OF AROMATIC POLYMERS FOR ANION EXCHANGE MEMBRANES

(71) Applicant: Rensselaer Polytechnic Institute, Troy, NY (US)

(72) Inventors: Chulsung Bae, Cohoes, NY (US); Jong Yeob Jeon, Troy, NY (US); Junyoung Han, Troy, NY (US); Sangtaik Noh, Troy, NY (US)

(73) Assignee: Rensselaer Polytechnic Institute, Troy, NY (US)

(21) Appl. No.: 19/328,524

(22) Filed: Sep. 15, 2025

Related U.S. Application Data
(63) Continuation of application No. 17/050,256, now Pat. No. 12,448,508.
(60) Provisional application No. 62/661,705, filed on Apr. 24, 2018.

(51) Int. Cl. C08L 53/02; B01D 67/00; B01D 69/02; B01D 71/28; B01D 71/80; B01D 71/82; B01J 41/14; C08J 5/22

(52) U.S. Cl. CPC C08L 53/02; B01D 67/0006; B01D 67/00931; B01D 69/02; B01D 71/281; B01D 71/80; B01D 71/82; B01J 41/14; C08J 5/2237; B01D 2323/30; B01D 2323/36; B01D 2325/16; B01D 2325/42; C08J 2353/02; C08J 2453/02

(57) ABSTRACT

An ion exchange membrane material is composed of a crosslinked polymer network including a first poly(styrene-b-ethylene-r-butylene-b-styrene) triblock copolymer (SEBS), and second SEBS, and a linker crosslinking the first SEBS and the second SEBS. At least one phenyl group from the first SEBS and the second SEBS is functionalized with an alkyl group, and the carbon at the benzylic position of these alkyl groups is saturated with at least two additional alkyl groups. The linker is a diamine bound to the alkyl functional groups. The ion exchange membrane material is made via a substantially simultaneous quaternization and crosslinking reaction between the diamine linker and SEBS functionalized with alkyl halide groups. Increasing concentration of crosslinker produces membranes with reduced water uptake, leading to an expectation of enhanced stability under hydrated conditions and greater durability. Advantageously, this reduction in water uptake came with little change to ion exchange capacity.

### CROSS REFERENCE TO RELATED APPLICATION(S)

This application is a continuation of U.S. Non-Provisional application Ser. No. 17/050,256, filed Oct. 23, 2020, which is a U.S. National Phase Application under 35 U.S.C. § 371 of PCT Application No. PCT/US2019/028925, titled “CROSSLINKING OF AROMATIC POLYMERS FOR ANION EXCHANGE MEMBRANES,” filed Apr. 24, 2019, which claims the benefit of U.S. Provisional Application No. 62/661,705, filed Apr. 24, 2018, each of which is incorporated by reference as if disclosed herein in its entirety.

### STATEMENT REGARDING FEDERALLY SPONSORED RESEARCH OR DEVELOPMENT

This invention was made with government support under grant no. DE-AR0000769 awarded by the Department of Energy. The government has certain rights in the invention.

### BACKGROUND

Alkaline exchange membranes (AEMs), also called anion exchange membranes, allow transportation of anions, e.g., OH⁻, Cl⁻, Br⁻, etc., from a cathode to an anode in electrochemical reaction. AEMs are a component of AEM fuel cells where hydrogen and oxygen are used to generate electricity and water by-product. AEMs are also used in water electrolysis, where water splits into hydrogen and oxygen with the help of electricity, the cleanest and the most desirable process of hydrogen production. In AEM fuel cells and water electrolysis, hydroxide ions (OH⁻) are transported through the membrane with the help of water molecules. Other areas of AEMs use include battery, sensors, and actuators (plastic membranes swing reversibly as a result of the migration of ions).

Over the last several years, several research groups have developed new AEM materials. However, these materials disadvantageously tend to degrade easily under high alkaline conditions. Currently, most anion AEMs are prepared from polymers containing a quaternary ammonium group along the side chains. Unfortunately, these ionic side groups interact with water strongly, which acts as a plasticizer and causes softening of the polymer and swelling upon hydration.

### SUMMARY

Some embodiments of the present disclosure are directed to an ion exchange membrane material composed of a crosslinked polymer network including a first poly(styrene-b-ethylene-r-butylene-b-styrene) triblock copolymer (SEBS), wherein at least one phenyl group of the first SEBS is functionalized with a first alkyl group, and the carbon at the benzylic position of the first alkyl group is saturated with at least two additional alkyl groups, a second poly(styrene-b-ethylene-r-butylene-b-styrene) triblock copolymer (SEBS), wherein at least one phenyl group of the second SEBS is functionalized with a second alkyl group, and the carbon at the benzylic position of the second alkyl group is saturated with at least two additional alkyl groups, and a diamine linker bound to the first alkyl group and the second alkyl group. In some embodiments, at least one phenyl group of the first SEBS is functionalized with an uncrosslinked alkyl group, the carbon at the benzylic position of the uncrosslinked alkyl group is saturated with at least two additional alkyl groups, the uncrosslinked alkyl group including a quaternary ammonium group. In some embodiments, at least one phenyl group of the second SEBS is functionalized with an uncrosslinked alkyl group, the carbon at the benzylic position of the uncrosslinked alkyl group is saturated with at least two additional alkyl groups, the uncrosslinked alkyl group including a quaternary ammonium group. In some embodiments, the concentration of diamine linker in the crosslinked polymer network is greater than about 5 mol %. In some embodiments, the concentration of diamine linker in the crosslinked polymer network is greater than about 30 mol %. In some embodiments, the concentration of diamine linker in the crosslinked polymer network is about 50 mol %. In some embodiments, the diamine linker is N,N,N′,N′-tetramethyl-1,6-hexanediamine.

Some embodiments of the present disclosure are directed to a method of making an ion exchange membrane including functionalizing an aromatic block copolymer with one or more alkyl halide groups, the carbon at the benzylic position of the one or more alkyl halide groups being saturated with at least two additional alkyl groups, mixing the functionalized aromatic block copolymer with a diamine to replace one or more halide groups with a quaternary ammonium group, and crosslinking the functionalized aromatic block copolymer with another functionalized aromatic block copolymer via the diamine to create a crosslinked polymer. In some embodiments, the linker is a diamine linker, a polyol, a polyaromatic compound, an alkene dimer, a dithiol, or combinations thereof. In some embodiments, the diamine has two tertiary amine groups. In some embodiments, the method includes adding trialkylamine to the crosslinked polymer to convert unreacted alkyl halide groups to quaternary ammonium groups. In some embodiments, the aromatic block copolymer is a biphenyl polymer.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a schematic drawing of an ion exchange material for use in making an ion exchange membrane according to some embodiments of the present disclosure.

FIG. 2 is a chart of a method for making an ion exchange membrane according to some embodiments of the present disclosure

FIG. 3 is a table showing decreases in water uptake with increases in crosslinker in ion exchange materials according to some embodiments of the present disclosure.

FIG. 4 is a chart of a method for making an ion exchange membrane according to some embodiments of the present disclosure.

FIG. 5 is a chart of a method for making an ion exchange membrane according to some embodiments of the present disclosure.

FIG. 6 is a chart of a method for making an ion exchange membrane according to some embodiments of the present disclosure.

FIG. 7 is a chart of a method for making an ion exchange membrane according to some embodiments of the present disclosure.

FIG. 8 is a chart of a method for making an ion exchange membrane according to some embodiments of the present disclosure.

FIG. 9 is a chart of a method for making an ion exchange membrane according to some embodiments of the present disclosure.

### DETAILED DESCRIPTION

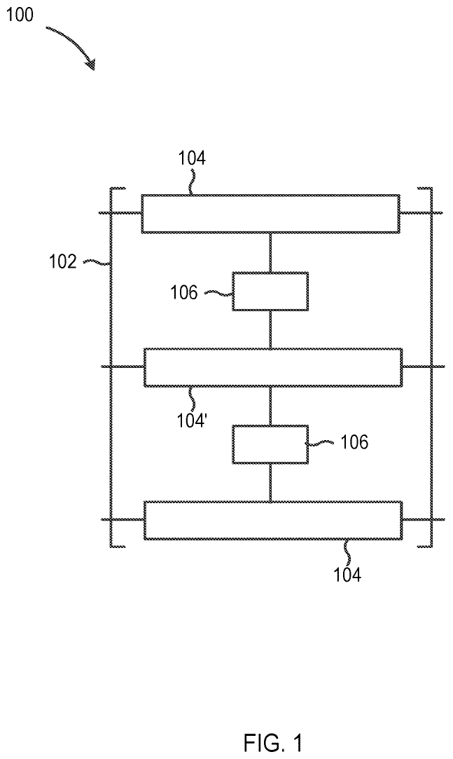

Referring now to FIG. 1, some aspects of the disclosed subject matter include an ion exchange material 100. In some embodiments, the ion exchange material is suitable as an ion exchange membrane for use in, e.g., fuel cells, water hydrolysis systems, electrochemical hydrogen compressors, batteries, sensors, actuators, etc. In some embodiments, the ion exchange membrane is an anion exchange membrane.

In some embodiments, ion exchange material 100 includes a crosslinked polymer network 102. In some embodiments, crosslinked network 102 includes one or more polymeric chains 104 and one or more linkers 106 linking the one or more polymeric chains 104. In some embodiments, polymeric chains 104 are polyaromatic polymers, copolymers, block copolymers, or combinations thereof. In some embodiments, polymeric chains 104 are functionalized with one or more functional groups.

In some embodiments, one or more of polymeric chains 104 is poly(styrene-b-ethylene-r-butylene-b-styrene) triblock copolymer (SEBS). In some embodiments, at least one phenyl group of polymeric chains 104, e.g., SEBS, is functionalized with at least one alkyl group. In some embodiments, the carbon at the benzylic position of the at least one alkyl group is saturated with at least two additional carbons, alkyl groups, etc. In some embodiments, the at least one alkyl group is an alkyl halide group prior to crosslinking to another polymeric chain 104 via one or more linkers 106, as will be discussed in greater detail below. In some embodiments, linkers 106 crosslink polymeric chains 104 via binding between the alkyl functional groups on the polymeric chains. In some embodiments, linker 106 is a diamine. In some embodiments, the diamine includes at least two tertiary amine groups with an alkyl group disposed therebetween. In some embodiments, the linker is N,N,N′,N′-tetramethyl-1,6-hexanediamine. In some embodiments, at least one phenyl group of crosslinked network 102 is functionalized with an uncrosslinked alkyl group, the carbon at the benzylic position of the uncrosslinked alkyl group is saturated with at least two additional alkyl groups, the uncrosslinked alkyl group including a quaternary ammonium group.

In some embodiments, the concentration of the linker in the crosslinked polymer network is greater than about 5 mol % of the alkyl functional group. In some embodiments, the concentration of the linker in the crosslinked polymer network is greater than about 30 mol % of the alkyl functional group. In some embodiments, the concentration of the linker in the crosslinked polymer network is about 50 mol % of the alkyl functional group. In some embodiments, the concentration of the linker in the crosslinked polymer network is greater than about 50 mol % of the alkyl functional group.

By way of example, and still referring to FIG. 1, crosslinked polymer network 102 includes a first SEBS chain 104, wherein at least one phenyl group of the first SEBS is functionalized with a first alkyl group, and the carbon at the benzylic position of the first alkyl group is saturated with at least two additional alkyl groups. The first SEBS chain 104 is crosslinked with a second SEBS chain 104′, wherein at least one phenyl group of the second SEBS is functionalized with a second alkyl group, and the carbon at the benzylic position of the second alkyl group is saturated with at least two additional alkyl groups. A diamine linker 106 is bound to the first alkyl group and the second alkyl group, resulting in the structure according to formula I:

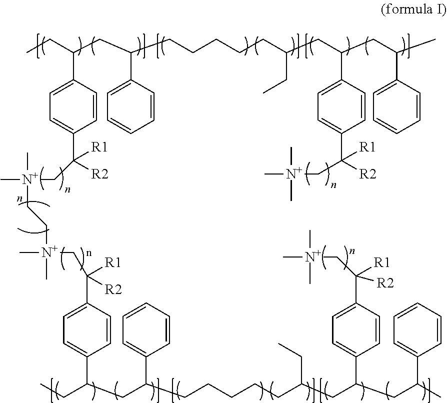

wherein R1 includes H or CH₃ and R2 includes CH₃.

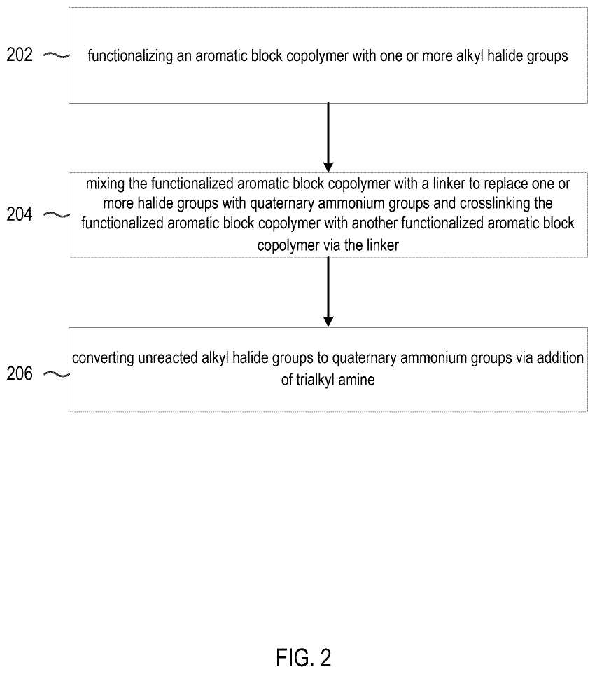

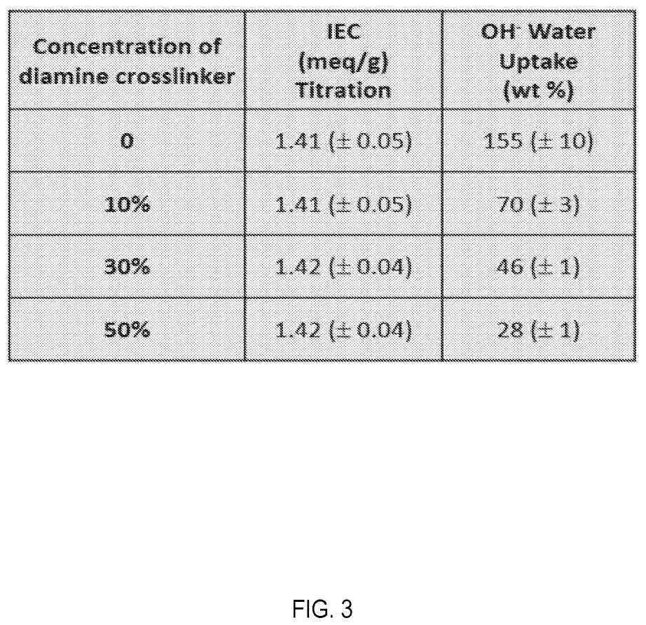

Referring now to FIG. 2, some embodiments of the present disclosure are directed a method, e.g., a reaction pathway, for making an ion exchange membrane. At 202, an aromatic block copolymer, e.g., SEBS, is functionalized with one or more alkyl halide groups. In some embodiments, the carbon at the benzylic position of the one or more alkyl halide groups is saturated with at least two additional alkyl groups. At 204, the functionalized aromatic block copolymer is mixed with a linker to replace one or more halide groups with quaternary ammonium groups and crosslinking the functionalized aromatic block copolymer with another functionalized aromatic block copolymer via the linker to create a crosslinked polymer network. At 206, unreacted alkyl halide groups are converted to quaternary ammonium groups via addition of trialkylamine. Referring to FIG. 3, the higher the concentration (mol %) of the linker, the lower the water uptake of the network and thus the membrane.

Referring again to FIG. 1, in some embodiments, one or more polymeric chains 104 is a biphenyl block polymer. In some embodiments, the biphenyl block polymer is functionalized with one or more alkyl groups. In some embodiments, linkers 106 crosslink the biphenyl block polymer via binding between the alkyl functional groups on the chains. In some embodiments, the linker is a diamine linker, a polyol, a polyaromatic compound, an alkene dimer, a dithiol, or combinations thereof, as will be discussed in greater detail below. In some embodiments, the concentration of the linker in the crosslinked biphenyl block polymer network is greater than about 5 mol % of the alkyl functional group. In some embodiments, the concentration of the linker in the crosslinked biphenyl block polymer network is greater than about 30 mol % of the alkyl functional group. In some embodiments, the concentration of the linker in the biphenyl block crosslinked polymer network is about 50 mol % of alkyl functional group. In some embodiments, the concentration of the linker in the biphenyl block crosslinked polymer network is greater than about 50 mol % of the alkyl functional group. In some embodiments, at least one alkyl functional group is uncrosslinked and includes a quaternary ammonium group.

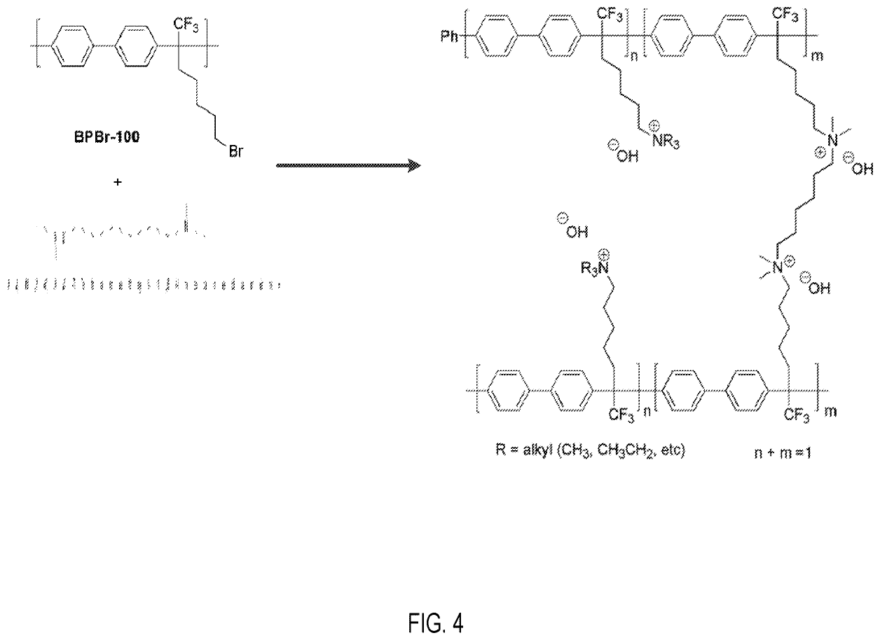

Referring now to FIG. 4, in some embodiments, one or more biphenyl block polymers is functionalized with alkyl halide groups. In some embodiments, the one or more biphenyl block polymers are mixed, e.g., cast, with a linker, e.g., a diamine, undergoing a substantially simultaneous quaternization and crosslinking reaction and crosslinking to other biphenyl block polymers. In some embodiments, unreacted alkyl halide groups are converted to quaternary ammonium groups via the addition of trialkylamine.

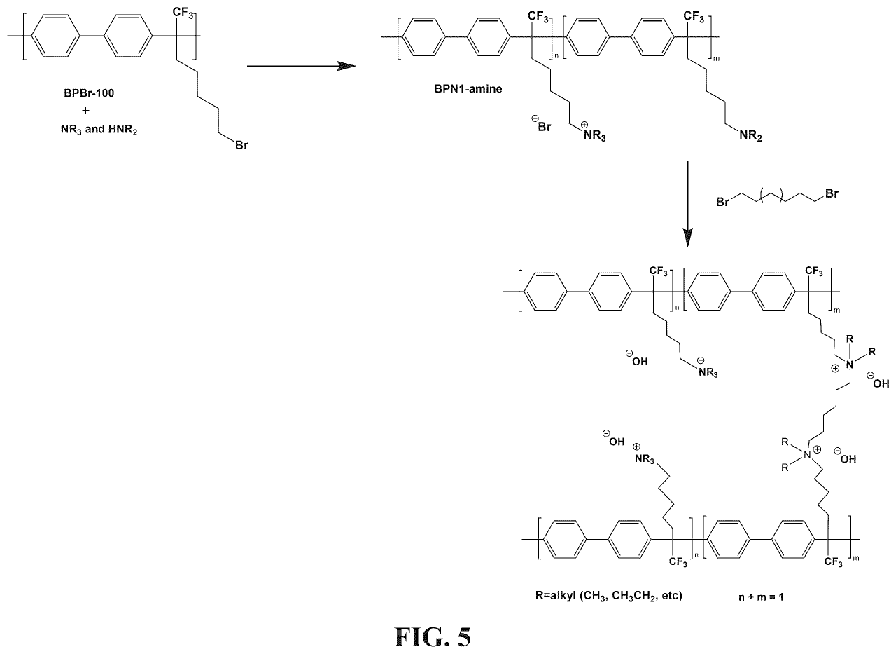

Referring now to FIG. 5, in some embodiments, one or more biphenyl block polymers is functionalized with alkyl halide groups. In some embodiments, a mixture of trialkylamines and dialkyl amines is added to the biphenyl block polymers to convert the halogen in the alkyl halide groups to a mixture of quaternary ammonium and tertiary amine groups. In some embodiments, the one or more biphenyl block polymers are mixed, e.g., cast, with a linker, e.g., a diamine, undergoing a substantially simultaneous quaternization and crosslinking reaction at the tertiary amine groups.

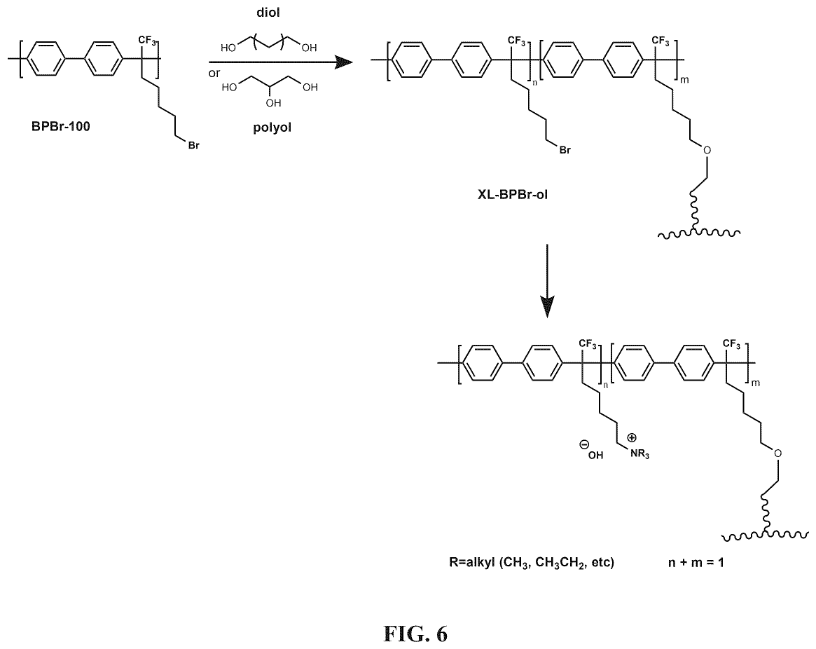

Referring now to FIG. 6, in some embodiments, one or more biphenyl block polymers is functionalized with alkyl halide groups. In some embodiments, the one or more biphenyl block polymers are mixed, e.g., cast, with a polyol such as a diol or a triol, undergoing an etherification reaction and crosslinking to other biphenyl block polymers. In some embodiments, unreacted alkyl halide groups are converted to quaternary ammonium groups via the addition of trialkylamine.

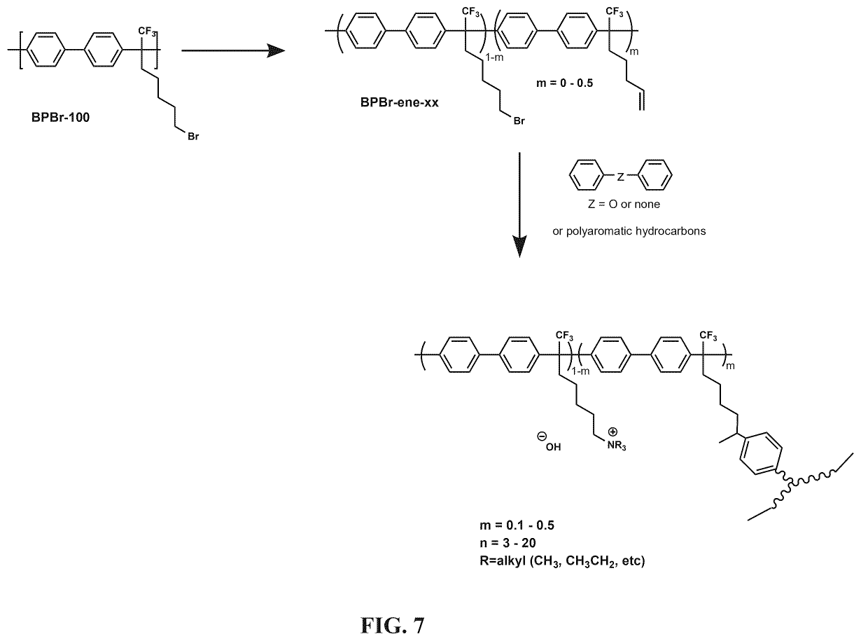

Referring now to FIG. 7, in some embodiments, one or more biphenyl block polymers is functionalized with alkyl halide groups. In some embodiments, the one or more biphenyl block polymers are reacted with a base to convert at least some halogens to a vinyl group. In some embodiments, the vinyl group undergoes a crosslinking reaction via acid-catalyzed Fridel-Crafts alkylation with a polyaromatic compound such that an aromatic ring serves as a linker between the polymers in a crosslinked polymer network. In some embodiments, the polyaromatic compound includes a biphenyl compound, a diphenyl ether compound, a triptycene compound, a fluorene or fluorene derivative compound, etc., or combinations thereof. In some embodiments, unreacted alkyl halide groups are converted to quaternary ammonium groups via addition of trialkylamine.

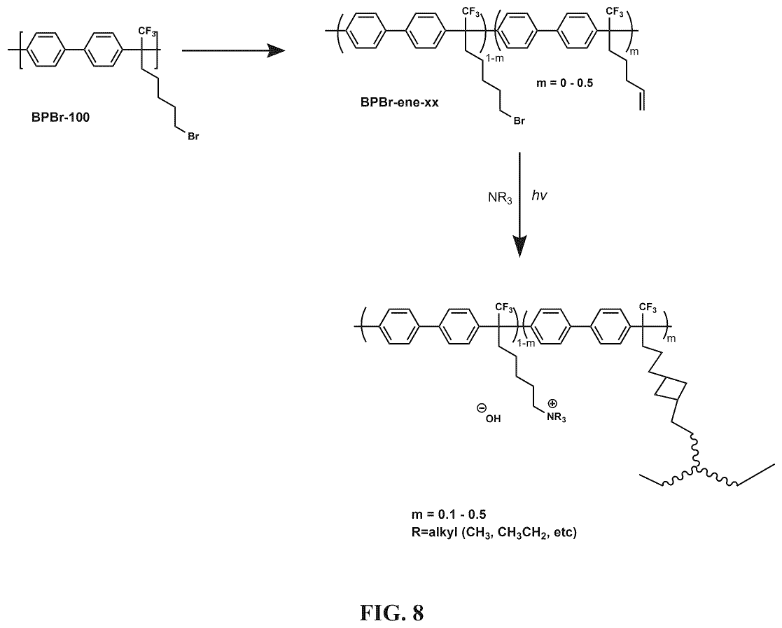

Referring now to FIG. 8, in some embodiments, one or more biphenyl block polymers is functionalized with alkyl halide groups. In some embodiments, the one or more biphenyl block polymers are reacted with a base to convert at least some halogens to a vinyl group. In some embodiments, the one or more biphenyl block polymers are then UV-irradiated, causing dimerization between the vinyl groups as a cyclobutane ring, which serves as a linker between the polymers in a crosslinked polymer network. In some embodiments, unreacted alkyl halide groups are converted to quaternary ammonium groups via addition of trialkylamine.

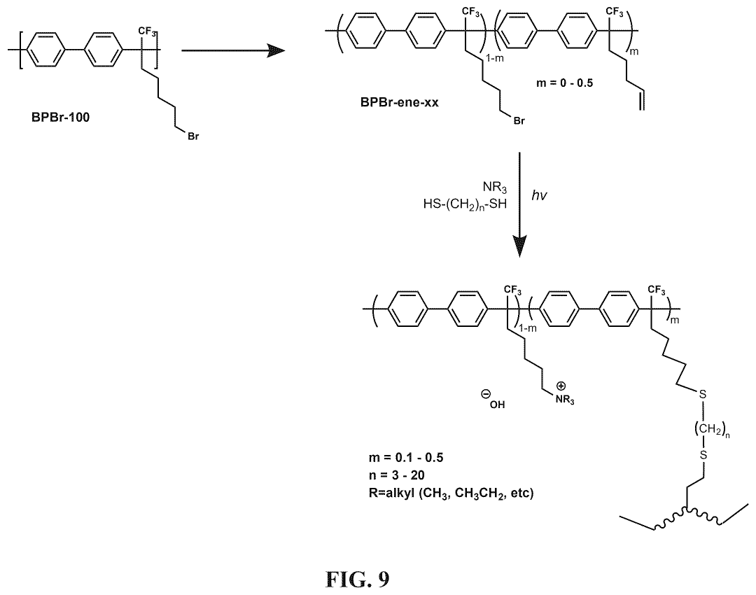

Referring now to FIG. 9, in some embodiments, one or more biphenyl block polymers is functionalized with alkyl halide groups. In some embodiments, the one or more biphenyl block polymers are reacted with a base to convert at least some halogens to a vinyl group. In some embodiments, the vinyl group undergoes a crosslinking reaction via UV-irradiation and addition of a dithiol. The resulting thiolene reaction crosslinks the polymers in the crosslinked polymer network where the dithiol serves as the linker. In some embodiments, the dithiol is an alkyl dithiol, e.g., SH—(CH₂) n-SH. In some embodiments, unreacted alkyl halide groups are converted to quaternary ammonium groups via addition of trialkylamine.

Methods of the present disclosure are advantageous as a versatile approach to preparing ion exchange membranes and ionomer binders from any styrene copolymers functionalized with alkyl halide groups. The reaction conditions are straightforward and the reactions themselves can be carried out in a relatively low amount of steps, as quaternization and crosslinking occur substantially simultaneously. Further, simply increasing concentration of crosslinker in the reactions described herein produced membranes with reduced water uptake, leading to an expectation of enhanced stability under hydrated conditions and greater durability. Advantageously, this reduction in water uptake came with little change to ion exchange capacity. The crosslinked polymer networks consistent with the embodiments of the present disclosure are useful for applications such as batteries, anion exchange membrane fuel cells, anion exchange membrane electrolysis, ionomer for fuel cells and electrolysis, membrane and ionomer for other electrochemical energy conversion devices, water purification, gas separation (particularly CO₂ from coal-fired power plants), etc.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

1. A method of making an ion exchange membrane comprising:
functionalizing an aromatic polymer with one or more alkyl halide groups, wherein the carbon at the benzylic position of the one or more alkyl halide groups being saturated with at least two additional alkyl groups or wherein the one or more alkyl halide groups being attached to an aromatic main-chain polymer;
mixing the functionalized aromatic polymer with a diamine to replace one or more halide groups with a quaternary ammonium group; and
crosslinking the functionalized aromatic polymer with another functionalized aromatic polymer via the diamine to create a crosslinked polymer.

2. The method according to claim 1, further comprising adding trialkyl amine to the crosslinked polymer to convert unreacted alkyl halide groups to quaternary ammonium groups.

3. The method according to claim 1, wherein the concentration of diamine linker in the crosslinked polymer is greater than about 5 mol % or greater than about 50 mol %.

4. The method according to claim 1, wherein the diamine linker includes two tertiary amine groups.

5. The method according to claim 4, wherein the diamine linker is N,N,N,N′-tetramethyl-1,6-hexanediamine.

6. The method according to claim 1, wherein the ion exchange membrane comprises the structure according to formula I: 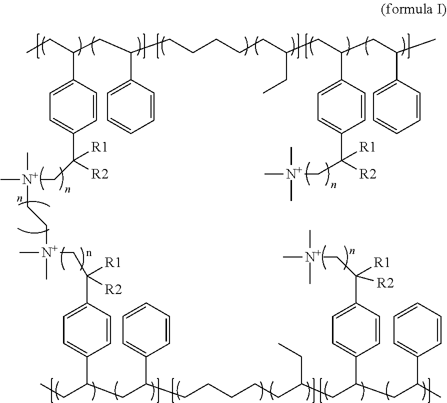
wherein R1 includes H or CH₃ and R2 includes CH₃.

7. A method of making an ion exchange membrane comprising:
functionalizing an aromatic polymer with one or more alkyl halide groups and one or more optional vinyl groups;
crosslinking the functionalized aromatic polymer with another functionalized aromatic polymer at the one or more alkyl halide groups or at the one or more optional vinyl groups to create a crosslinked polymer via a linker; and
treating the crosslinked polymer with trialkyl amine to convert uncrosslinked alkyl halide groups to ammonium groups.

8. The method according to claim 7, wherein the concentration of the linker in the crosslinked polymer is greater than about 5 mol % or is about 50 mol %.

9. The method according to claim 7, wherein the aromatic polymer is a biphenyl polymer or a biphenyl copolymer.

10. The method according to claim 7, wherein the linker is a diamine linker, a polyol, a polyaromatic compound, alkene dimer, dithiol, or combinations thereof.
